(19) United States
(12) Patent Application Publication
(10) Pub. No.: US 2025/0206262 A1
(43) Pub. Date: Jun. 26, 2025

(54) VEHICLE, INFORMATION MANAGEMENT DEVICE, AND INFORMATION MANAGEMENT METHOD

(71) Applicant: TOYOTA JIDOSHA KABUSHIKI KAISHA, Toyota-shi (JP)

(72) Inventors: Hiroki HOMMA, Toyota-shi (JP); Yosuke HASEGAWA, Nagoya-shi (JP); Junji MURASE, Nagoya-shi (JP); Yuki MORI, Seki-shi (JP)

(73) Assignee: TOYOTA JIDOSHA KABUSHIKI KAISHA, Toyota-shi (JP)

(21) Appl. No.: 18/936,070

(22) Filed: Nov. 4, 2024

(30) Foreign Application Priority Data
Dec. 21, 2023 (JP) 2023-215852

(51) Int. Cl. B60R 25/24

(52) U.S. Cl. CPC B60R 25/24

(57) ABSTRACT

A vehicle configured to utilize a digital key registered in a mobile information terminal of a user, in which the vehicle includes a processor configured to transmit, to a management server for the digital key, log information of an event occurring in the vehicle when registering the digital key to the mobile information terminal.

### CROSS-REFERENCE TO RELATED APPLICATION

This application claims priority to Japanese Patent Application No. 2023-215852 filed on Dec. 21, 2023, incorporated herein by reference in its entirety.

### BACKGROUND

### 1. Technical Field

The present disclosure relates to a vehicle, an information management device, and an information management method.

### 2. Description of Related Art

As described in Japanese Unexamined Patent Application Publication No. 2007-280160 (JP 2007-280160 A), a system known as a digital key is in practical use, in which a mobile information terminal such as a smartphone or the like is used to lock, unlock, start, and otherwise operate a vehicle, instead of using a physical key. It is conceivable that the digital key will be registered in the mobile information terminal, using an application program installed in the mobile information terminal.

### SUMMARY

There are some cases in which, for some reason, the digital key registration processing is not completed successfully. In order to identify the cause of such a case, it may be desirable to manage a registration processing log in a management server of a digital key service. To achieve this, an application program needs to be designed for the mobile information terminal used to register the digital key (hereafter referred to as “registration application”) such that logs necessary to identify the cause are recorded.

It is conceivable that a party other than the provider of the digital key service, such as a provider of an operating system (OS) for the mobile information terminal, for example, might develop a digital key registration application. Specifications of such registration applications do not necessarily meet the needs of providers of digital key services. Accordingly, depending on the specifications of the registration application, there is a possibility that the log of the registration processing necessary for identifying the cause of the problem or the like may not be uploaded from the mobile information terminal to the management server.

The vehicle disclosed in the present disclosure is configured to utilize a digital key registered in a mobile information terminal of a user, in which the vehicle includes a processor configured to transmit, to a management server for the digital key, log information of an event occurring in the vehicle when the digital key is registered to the mobile information terminal.

The processor may be configured to transmit, to the management server, information indicating that key exchange with the mobile information terminal is completed, as the log information.

The processor may be configured to transmit, to the management server, log information of an event that occurred in the vehicle when the digital key is deleted.

An information management device according to the present disclosure is an information management device configured to manage information regarding progress of registration of a digital key for a vehicle to a mobile information terminal of a user, and includes a processor and data storage, in which the processor is configured to acquire, from the vehicle, log information of an event occurring in the vehicle when the digital key is registered, and record the log information in the data storage, and acquire, from the mobile information terminal, log information of processing carried out at the mobile information terminal when registering the digital key, and record the log information in the data storage.

The log information of the event may include one or more of completion of pairing between the vehicle and the mobile information terminal, completion of exchange of a temporary key generated in the vehicle and a temporary key generated in the mobile information terminal, and completion of exchange of mutual authentication data generated in the vehicle using the temporary key that is exchanged, and mutual authentication data generated in the mobile information terminal using the temporary key that is exchanged. Registration of the digital key may be completed in accordance with the vehicle and the mobile information terminal each completing generation of an encryption key using the mutual authentication data that is exchanged, the encryption key being used for mutual authentication between the vehicle and the mobile information terminal when the digital key is used.

The log information of the event may include one or more of completion of deleting the encryption key in the mobile information terminal, and completion of deleting the encryption key in the vehicle.

The data storage may be configured to store information related to the digital key. The processor may be configured to delete a part of the information relating to the digital key from the data storage in response to the completion of deleting the encryption key being recorded as the log information.

An information management method according to the present disclosure is an information management method for managing information regarding progress of registration of a digital key for a vehicle to a mobile information terminal of a user, and includes storing the information in data storage, in which storing the information in the data storage is carried out by a processor, and processing by the processor relating to storing the information in the data storage includes acquiring, from the vehicle, log information of events occurring in the vehicle when registering the digital key, and recording the log information.

Processing by the processor relating to storing the information in the data storage may include acquiring, from the mobile information terminal, log information of processing carried out at the mobile information terminal when registering the digital key, and recording the log information.

The vehicle, the information management device, and the information management method have effects of facilitating diagnosis and analysis of the registration processing of the digital key.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a schematic configuration of an embodiment of a vehicle and an information management device;

FIG. 2 is a sequence diagram of digital key registration processing; and

FIG. 3 is a sequence diagram of digital key deletion processing.

### DETAILED DESCRIPTION OF EMBODIMENTS

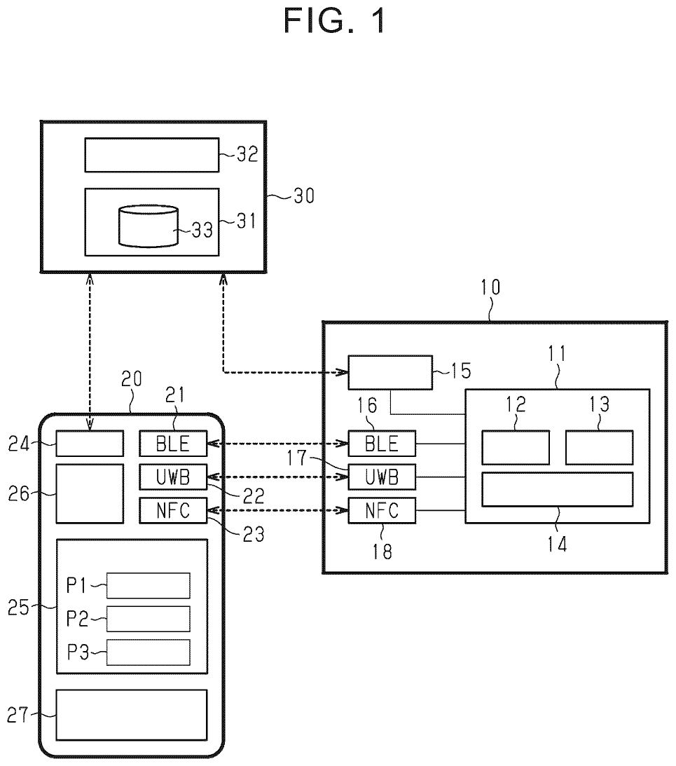

Hereinafter, an embodiment of a vehicle, an information management device, and an information management method will be described in detail with reference to FIGS. 1 to 3.

### Configuration of Vehicle and Information Management Device

First, configurations of the vehicle 10 and the information management device according to the present embodiment will be described. The vehicle 10 according to the present embodiment is capable of using a digital key. The digital key is a system in which, instead of a physical key, a user uses a mobile information terminal 20 such as a smartphone or the like owned by the user to perform locking, unlocking, starting, and so forth. The information management device is a device that manages information related to digital keys, and is operated by a provider of a digital key service. The digital key used by the vehicle 10 of the present embodiment complies with the Car Connectivity Consortium (CCC) standard.

The vehicle 10 is equipped with a digital key ECU 11. The digital key ECU 11 is an electronic control unit (ECU) that performs processing related to the digital key. The digital key ECU 11 includes a storage module 13 in which a program is stored, and a processor 12 that reads the program from the storage module 13 and performs execution thereof. The digital key ECU 11 includes an Hardware Security Module (HSM) 14 that generates and stores an encryption key, performs encryption using the encryption key, imparts an electronic signature, and so forth. The vehicle 10 is equipped with a Telematics Control Unit (TCU) 15 for communicating with a management server 30 using mobile communication. The vehicle 10 is equipped with communication modules 16 to 18 that are compatible with Bluetooth Low Energy (BLE) communication, ultra-wide band (UWB) communication, and near-field communication (NFC), respectively. The vehicle 10 communicates with the mobile information terminal 20 of the user by BLE communication, UWB communication, and NFC. The TCU 15 can communicate with the management server 30 in accordance with instructions from the processor 12. The communication modules 16 to 18 are capable of communicating with the mobile information terminal 20 in accordance with instructions from the processor 12.

The mobile information terminal 20 is equipped with communication modules 21 to 23 for BLE communication, UWB communication, and NFC for communicating with the vehicle 10. The mobile information terminal 20 includes a communication module 24 for cellular communication for communicating with the management server 30 using mobile communication. The mobile information terminal 20 includes a storage module 25, a processor 26, and a secure element 27. The processor 26 reads and executes programs stored in the storage module 25. The secure element 27 is a semiconductor device including tamper-resistant memory and a cryptographic logic circuit.

A native application Pl and a digital key framework P2 are stored in advance in the storage module 25 of the mobile information terminal 20. The native application P1 is an application program that provides a user interface (UI) for performing creating, terminating, deleting, enabling, disabling, and so forth, of digital keys. The digital key framework P2 is a program that uses an Application Programming Interface (API) provided in the OS to provide functions such as owner pairing, sharing and management of digital keys, and so forth. Owner pairing is processing of downloading digital key information to the mobile information terminal 20, associating the vehicle 10 with the mobile information terminal 20, and registering the digital key to the vehicle 10. The native application P1 and the digital key framework P2 are created by the provider of the operating system (OS) of the mobile information terminal 20 and are pre-installed in the mobile information terminal 20.

The provider of the digital key service provides a vehicle original equipment manufacturer (OEM) application P3. The vehicle OEM application P3 is an application program that provides the same functions as the native application P1. The vehicle OEM application P3 is installed in the mobile information terminal 20 at the discretion of the user. The digital key can be registered in the mobile information terminal 20 using either the native application Pl or the vehicle OEM application P3.

The management server 30 is a server device operated by the provider of the digital key service. The management server 30 includes a processor 32 and data storage 31. The management server 30 provides various types of functions related to the digital key service by the processor 32 executing the programs stored in the data storage 31. Examples of functions provided by the management server 30 include information management of the vehicle 10 and of the users, integrated management of data required for digital keys, creation and transmission of data for owner pairing, and key tracking. The data storage 31 stores a log management database 33 that records log information regarding registration/deletion processing for digital keys. The data storage 31 also stores a key tracing database. The key tracing database has recorded therein a vehicle database that records information regarding the vehicle 10, a user database that records information regarding the user, and usage history of the digital key. In the present embodiment, the management server 30 is an example of an information management device.

### Registration Processing of Digital Key

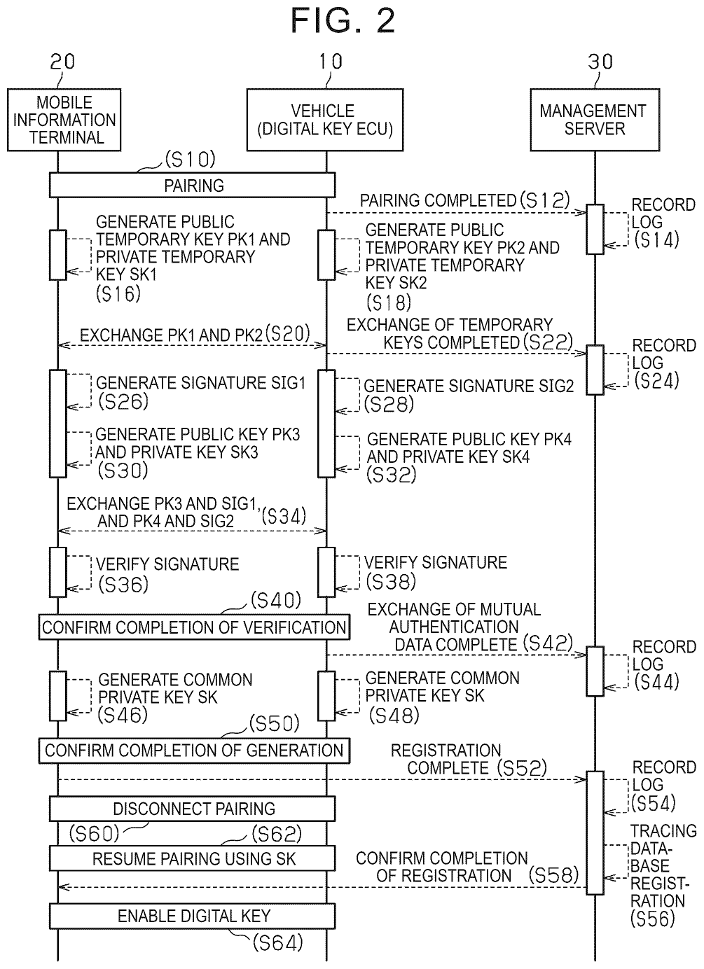

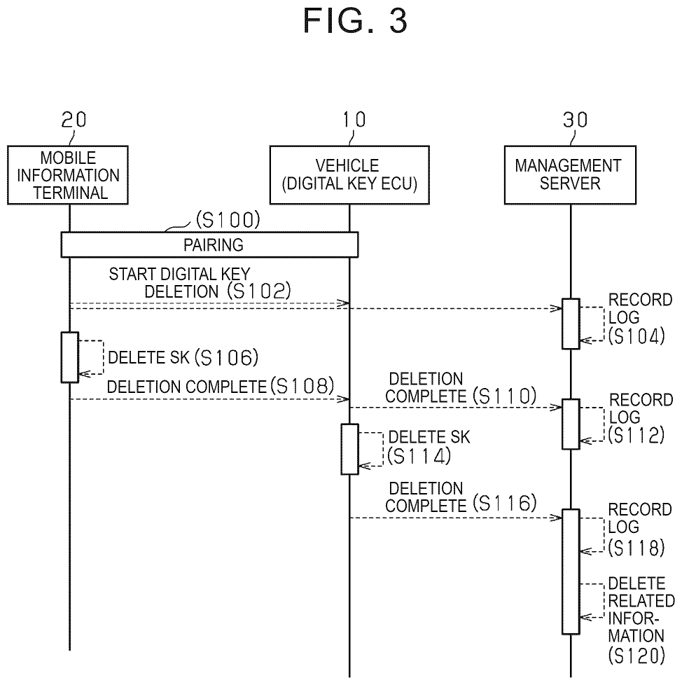

Next, the registration processing of the digital key will be described with reference to FIG. 2. The digital key is registered using either the native application P1 or the vehicle OEM application P3 installed in the mobile information terminal 20. Here, a case in which the native application P1 is used will be described. FIG. 2 shows processing procedures of the vehicle 10, the mobile information terminal 20, and the management server 30, when registering a digital key using the native application P1. The processing of the vehicle 10 shown in FIGS. 2 and 3, which will be described later, is executed by the processor 12 of the digital key ECU 11. Also, the processing of the management server 30 shown in FIGS. 2 and 3, which will be described later, are executed by the processor 32 of the management server 30.

In the registration processing, first, pairing between the mobile information terminal 20 and the vehicle 10 is performed using any one of BLE communication, UWB communication, and NFC (S10). The pairing here is performed using a digital key ID and a password that have been registered in advance in the vehicle 10 and the mobile information terminal 20. The digital key ID and the password are generated by the management server 30 in response to a registration application for the digital key, which is made by the user via the mobile information terminal 20, and are issued to the vehicle 10 and the mobile information terminal 20.

When the pairing is completed, the vehicle 10 transmits log information indicating the completion of the pairing to the management server 30 (S12). The management server 30 records the log information, which is received, in the log management database 33 (S14).

After completing the pairing, the mobile information terminal 20 generates a key pair of a public temporary key PK1 and a private temporary key SK1 (S16). Similarly, after completing the pairing, the vehicle 10 also generates a key pair of a public temporary key PK2 and a private temporary key SK2 (S18). The mobile information terminal 20 and the vehicle 10 then exchange the public temporary keys PK1 and PK2 (S20). When the key exchange is complete, the vehicle 10 transmits log information indicating the completion of the temporary key exchange to the management server 30 (S22). The management server 30 records the log information, which is received, in the log management database 33 (S24).

Next, the mobile information terminal 20 generates an electronic signature SIG1 using the public temporary key PK2 received from the vehicle 10 (S26). Similarly, the vehicle 10 generates an electronic signature SIG2 using the public temporary key PK1 received from the mobile information terminal 20. For example, the mobile information terminal 20 calculates a hash value of the public temporary keys PK1 and PK2, and also encrypts the hash value with the public temporary key PK2 received from the vehicle 10 to generate the electronic signature SIG1. Also, the vehicle 10 calculates a hash value of the public temporary keys PK1 and PK2, and encrypts the hash value with the public temporary key PK1 received from the mobile information terminal 20 to generate the electronic signature SIG2.

Further, the mobile information terminal 20 generates a key pair of a public key PK3 and a private key SK3, and the vehicle 10 generates a key pair of a public key PK4 and a private key SK4, respectively (S30, S32). The mobile information terminal 20 and the vehicle 10 then perform key exchange of the public keys PK3 and PK4 (S34). The mobile information terminal 20 and the vehicle 10 use the public keys PK3 and PK4 exchanged here as data for mutual authentication. During this key exchange, the mobile information terminal 20 imparts the electronic signature SIG1 to the public key PK3 and performs transmission thereof to the vehicle 10. Also, the vehicle 10 imparts the electronic signature SIG2 to the public key PK4 and performs transmission thereof to the mobile information terminal 20.

Thereafter, the mobile information terminal 20 and the vehicle 10 each perform verification of the electronic signatures SIG1 and SIG2 imparted to the respective public keys PK3 and PK4 (S36, S38). For example, the mobile information terminal 20 decrypts the electronic signature SIG2 received from the vehicle 10 using its own private temporary key SK1. The mobile information terminal 20 then performs verification of the electronic signature SIG2 by checking whether a value obtained by decrypting the electronic signature SIG2 matches the hash values of the public temporary keys PK1 and PK2 calculated by itself. Also, the vehicle 10 decrypts the electronic signature SIG1 received from the mobile information terminal 20 using its own private temporary key SK2. The vehicle 10 then performs verification of the electronic signature SIG1 by checking whether the value obtained by decrypting the electronic signature SIG1 matches the hash values of the public temporary keys PK1 and PK2 calculated by itself.

The mobile information terminal 20 and the vehicle 10 notify each other of the completion of the verification, thereby confirming the completion of the verification of the electronic signatures SIG1 and SIG2 at both sides (S40). This confirmation completes the exchange of public keys PK3 and PK4 used as data for mutual authentication. When the vehicle 10 confirms that the verification of the electronic signatures SIG1, SIG2 in both the vehicle 10 itself and the mobile information terminal 20 has been completed, the vehicle 10 transmits log information indicating the completion of the exchange of mutual authentication data to the management server 30 (S42). The management server 30 records the log information, which is received, in the log management database 33 (S44).

Thereafter, the mobile information terminal 20 generates a common private key SK using the public key PK4 received from the vehicle 10 and its own private key SK3 (S46). Also, the vehicle 10 generates a common private key SK using the public key PK3 received from the mobile information terminal 20 and its own private key SK4 (S48). The mobile information terminal 20 and the vehicle 10 notify each other of the completion of the generation of the common private key SK, thereby confirming the completion of the generation of the common private key SK at both sides (S50). Note that the mobile information terminal 20 stores the common private key SK in the secure element 27. The vehicle 10 also stores the common private key SK in the HSM 14. The common private key SK thus stored in the mobile information terminal 20 and the vehicle 10 is used for mutual authentication between the vehicle 10 and the mobile information terminal 20 when the digital key is used.

When the mobile information terminal 20 confirms that the generation of the common private key SK has been completed for both itself and the vehicle 10, the mobile information terminal 20 transmits log information indicating the completion of the registration of the digital key to the management server 30 (S52). The management server 30 records the log information that is received in the log management database 33 (S54). Also, the management server 30 registers the information of the digital key, regarding which registration is complete, in a key tracing database in order to start recording the usage history of the digital key (S56). The management server 30 then notifies the mobile information terminal 20 that confirmation has been made that registration of the digital key is complete (S58).

When the mobile information terminal 20 and the vehicle 10 confirm that generation of the common private key SK of both has been completed, the pairing with each other is temporarily disconnected (S60). The mobile information terminal 20 and the vehicle 10 then perform mutual authentication using the common private key SK and resume pairing (S62). Thereafter, the mobile information terminal 20 and the vehicle 10 enable the digital key upon the resumption of pairing and the notification of registration completion confirmation from the management server 30 being performed at both (S64). Enabling the digital key means placing the vehicle 10 into a state in which the vehicle 10 can be locked, unlocked, and started, using the mobile information terminal 20.

### Deletion Processing of Digital Key

Next, deletion processing of the digital key will be described with reference to FIG. 3. Deletion of a digital key is performed using either the native application P1 or the vehicle OEM application P3 installed in the mobile information terminal 20, in the same manner as with registration. Here, a case in which the native application P1 is used will be described. FIG. 3 shows processing procedures of the vehicle 10, the mobile information terminal 20, and the management server 30, when deleting a digital key using the native application P1.

In the deletion processing, first, pairing between the mobile information terminal 20 and the vehicle 10 is performed using any one of BLE communication, UWB communication, and NFC (S100). The pairing here is performed using the common private key SK generated at the time of registration. When pairing is completed, the mobile information terminal 20 notifies the vehicle 10 and the management server 30 of the start of deletion of the digital key (S102). In response to the notification, the management server 30 records log information indicating the start of deletion in the log management database 33 (S104).

Next, the mobile information terminal 20 deletes the common private key SK stored in its own secure element 27 (S106). The mobile information terminal 20 then notifies the vehicle 10 of the completion of deletion of the common private key SK (S108). In response to the notification, the vehicle 10 transmits, to the management server 30, log information indicating that the deletion of the common private key SK from the mobile information terminal 20 has been completed (S110). The management server 30 records the log information that is received in the log management database 33 (S112).

Next, the vehicle 10 deletes the common private key SK stored in its own HSM 14 (S114). The vehicle 10 then transmits log information indicating that the deletion of its own common private key SK has been completed to the management server 30 (S116). The management server 30 records the log information that is received in the log management database 33 (S118). The key tracing database or the like of the management server 30 stores information related to the digital key that is deleted. Some of this information will no longer be necessary once the digital key is no longer in use. The management server 30 deletes the information that is no longer necessary (S120).

Note that the log information transmitted to the management server 30 in S12, S22, S42, and S52 in FIG. 2, and in S102, S110, and S116 in FIG. 3, is imparted with a digital key ID and a time stamp. In S14, S24, S44, and S54 in FIG. 2, and in S104, S112, and S118 in FIG. 3, the management server 30 records the log information associated with the digital key ID together with a time stamp in the log management database 33.

Incidentally, specifications of the vehicle OEM application P3 may be the same as those of the native application P1, or may be different. For example, the specifications of vehicle OEM application P3 may be such that log information is transmitted from the mobile information terminal 20 to the management server 30 at the same time that the vehicle 10 transmits log information to the management server 30.

### Functions and Effects of Embodiment Functions and effects of the present embodiment will be described.

The vehicle 10 according to the present embodiment is capable of using a digital key registered in the mobile information terminal 20 of the user. Also, in the case of this vehicle 10, the registration or deletion of the digital key is performed using the native application P1 or the vehicle OEM application P3 installed on the mobile information terminal 20.

It is conceivable that the processing of registering or deleting a digital key may be interrupted for some reason. Even in such a case, by having log information of the registration/deletion processing recorded in the management server 30, the cause thereof can be easily identified. The vehicle OEM application P3 is created by the provider of the digital key service. Accordingly, the provider of the digital key service can design the vehicle OEM application P3 such that the management server 30 can collect sufficient log information.

On the other hand, the native application P1 is created by the provider of the OS of the mobile information terminal 20. Accordingly, when registration/deletion processing of the digital key is performed using the native application P1, there is a possibility that sufficient log information will not be transmitted from the mobile information terminal 20 to the management server 30. For example, in the case of the present embodiment, in the registration processing using the native application P1, log information is transmitted from the mobile information terminal 20 to the management server 30 only when registration is completed (S52 in FIG. 2). Also, in the deletion processing using the native application P1, log information is transmitted from the mobile information terminal 20 to the management server 30 only at the start of deletion (S102 in FIG. 3).

In the present embodiment, the vehicle 10 transmits log information of events that occur in the vehicle 10 when registering the digital key to the mobile information terminal 20 to the management server 30 for the digital key (S12, S22, S42, S52, and S58 in FIG. 2). The log information transmitted by the vehicle 10 to the management server 30 includes information indicating that the key exchange between the mobile information terminal 20 and the vehicle 10 has been completed (S22, S42). Further, at the time of deletion of the digital key as well, the vehicle 10 transmits log information of the event that occurred in the vehicle 10 to the management server 30.

The management server 30 includes the processor 32 and the data storage 31 in which the log management database 33 is stored. The processor 32 of the management server 30 acquires, from the vehicle 10, log information of events that occur in the vehicle 10 when a digital key is registered or deleted, and records the log information in the data storage 31. The processor 32 of the management server 30 also acquires, from the mobile information terminal 20, log information of the processing carried out by the mobile information terminal 20 when registering or deleting a digital key, and records the log information in the data storage 31. Accordingly, the log management database 33 collects log information of events that occur in the vehicle 10 when registering or deleting a digital key, and log information of processing performed at the mobile information terminal 20. Accordingly, regardless of the specifications of the application used to register and delete the digital key, log information of the registration and deletion processing can be recorded in the log management database 33 of the management server 30.

According to the present embodiment described above, the following effects can be achieved.

The vehicle 10 according to the present embodiment transmits, to the management server 30 for the digital key, log information of events that occur in the vehicle 10 when the digital key is being registered to the mobile information terminal 20. Accordingly, log information of the registration processing can be recorded in the management server 30, regardless of the specifications of the application in the mobile information terminal 20 used to register the digital key. Thus, the vehicle 10 according to the present embodiment has the effect of facilitating diagnosis and analysis of the registration processing of the digital key.

In the registration processing of the digital key, a key exchange is performed between the vehicle 10 and the mobile information terminal 20. The vehicle 10 according to the present embodiment then transmits, to the management server 30, information indicating that the key exchange with the mobile information terminal 20 has been completed, as log information. When the registration processing is interrupted, up to what stage the registration processing has progressed can be confirmed, by confirming whether log information on completion of the key exchange is recorded in the log management database 33.

At the time of deletion of the digital key, the vehicle 10 according to the present embodiment transmits log information of the event that occurred in the vehicle 10 to the management server 30. Accordingly, log information of the deletion processing can be recorded in the management server 30, regardless of the specifications of the application in the mobile information terminal 20 used to delete the digital key. Accordingly, the vehicle 10 of the present embodiment has the effect of facilitating diagnosis and analysis of the deletion processing of the digital key as well.

The processor 32 of the management server 30 according to the present embodiment acquires log information of events that occur in the vehicle 10 when registering or deleting a digital key to or from the vehicle 10, and records the log information in the data storage 31. The processor 32 also acquires, from the mobile information terminal 20, log information on the processing carried out by the mobile information terminal 20 when registering or deleting a digital key, and records the log information in the data storage 31. Accordingly, regardless of the specifications of the application of the mobile information terminal 20 used to register and delete a digital key, log information of the registration and deletion processing can be recorded in the data storage 31 of the management server 30. Thus, the management server 30 according to the present embodiment has the effect of facilitating diagnosis and analysis of the registration and deletion processing of the digital key.

The information management method according to the present embodiment is a method for managing information relating to the progress of registration or deletion of a digital key for the vehicle 10 to or from the mobile information terminal 20 of the user. In this method, the information is stored in the data storage 31 of the management server 30, and this storage is performed by the processor 32 of the management server 30. The processing of the processor 32 relating to storing information in the data storage 31 includes a step of acquiring and recording log information of events that occur in the vehicle 10 when registering or deleting the digital key to or from the vehicle 10. In this information management method, log information of the registration and deletion processing can be recorded in the management server 30 regardless of the specifications of the application of the mobile information terminal 20 used to register and delete the digital key. Thus, the information management method according to the present embodiment has the effects of facilitating diagnosis and analysis of the registration and deletion processing of the digital key.

In the information management method according to the present embodiment, the processing by the processor 32 regarding the storage of information in the data storage 31 includes a step of acquiring and recording log information, from the mobile information terminal 20, regarding the processing performed at the mobile information terminal 20 when registering or deleting a digital key. In this information management method, log information of the registration and deletion processing is acquired from both the vehicle 10 and the mobile information terminal 20. This facilitates diagnosing and analyzing the registration and deletion processing of the digital key, as compared to when log information is acquired only from the vehicle 10.

### Other Embodiments

The present embodiment can be carried out modified as follows. The present embodiment and the following modifications can be carried out combined with each other as long as no technical contradiction arises.

The registration and deletion processing of the digital key may be performed by procedures different from those shown in FIGS. 2 and 3.

When registering or deleting a digital key, the log information may be transmitted from the vehicle 10 to the management server 30, and from the mobile information terminal 20 to the management server 30, at times different from those shown in FIGS. 2 and 3. Also, when registering or deleting a digital key, the mobile information terminal 20 may be configured not to transmit log information to the management server 30. In this case, the management server 30 acquires log information only from the vehicle 10, out of the mobile information terminal 20 and the vehicle 10, and performs recording thereof in the log management database 33.

Of the registration processing and the deletion processing of the digital key, log information may be transmitted from the vehicle 10 to the management server 30 just during the registration processing.

Hardware configurations of the vehicle 10, the mobile information terminal 20, and the management server 30, may be different configurations from those shown in FIG. 1.

### Appendices

[Appendix 1] A vehicle that can utilize a digital key registered in a mobile information terminal of a user, wherein the vehicle transmits, to a management server for the digital key, log information of an event occurring in the vehicle when the digital key is registered to the mobile information terminal.

[Appendix 2] The vehicle according to Appendix 1 that transmits, to the management server, information indicating that key exchange with the mobile information terminal is completed, as the log information.

[Appendix 3] The vehicle according to Appendix 1 or Appendix 2 that transmits, to the management server, log information of an event that occurred in the vehicle when the digital key is deleted.

What is claimed is:

1. A vehicle configured to utilize a digital key registered in a mobile information terminal of a user, the vehicle comprising
a processor configured to transmit, to a management server for the digital key, log information of an event occurring in the vehicle when the digital key is registered to the mobile information terminal.

2. The vehicle according to claim 1, wherein
the processor is configured to transmit, to the management server, information indicating that key exchange with the mobile information terminal is completed, as the log information.

3. The vehicle according to claim 1, wherein
the processor is configured to transmit, to the management server, log information of an event that occurred in the vehicle when the digital key is deleted.

4. An information management device configured to manage information regarding progress of registration of a digital key for a vehicle to a mobile information terminal of a user, the information management device comprising:
a processor; and
data storage, wherein the processor is configured to
acquire, from the vehicle, log information of an event occurring in the vehicle when the digital key is registered, and record the log information in the data storage, and
acquire, from the mobile information terminal, log information of processing carried out at the mobile information terminal when registering the digital key, and record the log information in the data storage.

5. The information management device according to claim 4, wherein:
the log information of the event includes one or more of
completion of pairing between the vehicle and the mobile information terminal,
completion of exchange of a temporary key generated in the vehicle and a temporary key generated in the mobile information terminal, and
completion of exchange of mutual authentication data generated in the vehicle using the temporary key that is exchanged, and mutual authentication data generated in the mobile information terminal using the temporary key that is exchanged; and
registration of the digital key is completed in accordance with the vehicle and the mobile information terminal each completing generation of an encryption key using the mutual authentication data that is exchanged, the encryption key being used for mutual authentication between the vehicle and the mobile information terminal when the digital key is used.

6. The information management device according to claim 5, wherein the log information of the event includes one or more of
completion of deleting the encryption key in the mobile information terminal, and
completion of deleting the encryption key in the vehicle.

7. The information management device according to claim 6, wherein:
the data storage is configured to store information related to the digital key; and
the processor is configured to delete a part of information relating to the digital key from the data storage in response to the completion of deleting the encryption key being recorded as the log information.

8. An information management method for managing information regarding progress of registration of a digital key for a vehicle to a mobile information terminal of a user, the information management method comprising storing the information in data storage, wherein
storing the information in the data storage is carried out by a processor, and
processing by the processor relating to storing the information in the data storage includes acquiring, from the vehicle, log information of events occurring in the vehicle when registering the digital key, and recording the log information.

9. The information management method according to claim 8, wherein processing by the processor relating to storing the information in the data storage includes acquiring, from the mobile information terminal, log information of processing carried out at the mobile information terminal when registering the digital key, and recording the log information.
